(19) United States
(12) Patent Application Publication
(10) Pub. No.: US 2008/0046579 A1
(43) Pub. Date: Feb. 21, 2008

(54) Secure email recipient

(76) Inventor: Denis Brent Walton, Pittsburg, CA (US)

Correspondence Address: BRINKS HOFER GILSON & LIONE, P.O. BOX 10395, CHICAGO, IL, 60610, US

(21) Appl. No.: 11/506,275

(22) Filed: Aug. 18, 2006

(51) Int. Cl. H04L 9/00; G06F 15/16; G06F 17/00; H04K 1/00

(52) U.S. Cl. 709/229; 709/227; 726/1

(57) ABSTRACT

A system and method for authenticating electronic communications between a sender and a recipient via an email authentication server is described. The system includes a processor, a network interface in communication with the processor, the network interface capable of receiving an email from a sender and forwarding the email to a recipient and a memory unit in communication with the processor and having processor executable instructions. The processor executable instructions configure the processor to receive instructions to register a sender upon request from an unregistered sender, determine if the sender is approved by the recipient, and provide a current digital signature of the recipient to the sender if the sender is approved by the recipient.

### BACKGROUND

It is well known that an email sender can send an email to any email address so long as they know the specific email address. Many senders of unsolicited emails, commonly referred to as spammers, utilize computer programs to generate a sequential list of characters. Once the sequential list of characters is generated, a domain is then added to each entry in the sequential list of characters. For example, a spammer may generate a sequential list of characters and after each entry in the list, add the domain “@yahoo.com”. Thus, if this combination results in a functioning email address, this email address will receive the unsolicited email.

Some solutions to this problem of receiving unsolicited emails include the use of spam-blocking software. Generally, spam blocking software utilizes two forms of protection. The first form of protection prevents the delivery of emails by using a set of parameters set by the receiver of unsolicited emails. For example, these parameters may include any number of email addresses and/or email domains of known spammers. If an incoming email is from one of these email address, the email will be blocked. There are several drawbacks to this form of spam blocking. Spammers are able to overcome the spam-blocking technique by simply changing the address from which the unsolicited email originates. Additionally, the burden of setting the above mentioned parameters are on the receiver, requiring the receiver to take additional affirmative steps.

A second way of blocking unsolicited emails is through the use of spam-blocking software that includes algorithms designed to minimize the amount of unsolicited emails received by the recipient. Typically, these algorithms may include the addresses of well-know spammers, certain key words or phrases that would indicate that the incoming email is an unsolicited email and/or the ability to detect an incoming email being sent to numerous recipients. When an email is sent to numerous recipients, the likelihood that the email is an unsolicited email is significantly higher. This second method, although automated, has the drawback of potentially blocking emails that are not sent from spammers. Therefore, there is a need for an improved system and method for authenticating electronic communications between a sender and a recipient.

### BRIEF DESCRIPTION OF THE DRAWINGS

FIG. 1 is a block diagram of a computer network incorporating an email authentication server;

FIG. 2 is a block diagram of a method for authenticating electronic communications between a sender and a recipient;

FIG. 3 is a block diagram of a method for receiving electronic communications between a sender and a recipient; and

FIG. 4 is a block diagram of a general purpose computer system capable of executing the methods illustrated in FIG. 2 and/or FIG. 3.

### DETAILED DESCRIPTION

A system and method for authenticating electronic communications between a sender and a recipient via an email authentication server is described. The method includes the steps of registering the sender with the email authentication server, determining if the sender is approved by the recipient, and providing a current digital signature of the recipient to the sender if the sender is approved by the recipient.

The system includes a processor, a network interface in communication with the processor, where the network interface is capable of receiving an email from a sender and forwarding the email to a recipient, and a memory unit having processor executable instructions in communication with the processor. The processor executable instructions configure the processor to receive instructions to register a sender upon request from an unregistered sender, determine if the sender is approved by the recipient, and provide a current digital signature of the recipient to the sender if the sender is approved by the recipient. These and other advantages, features and embodiments of the invention will become apparent from the drawings, detailed description and claims, which follow.

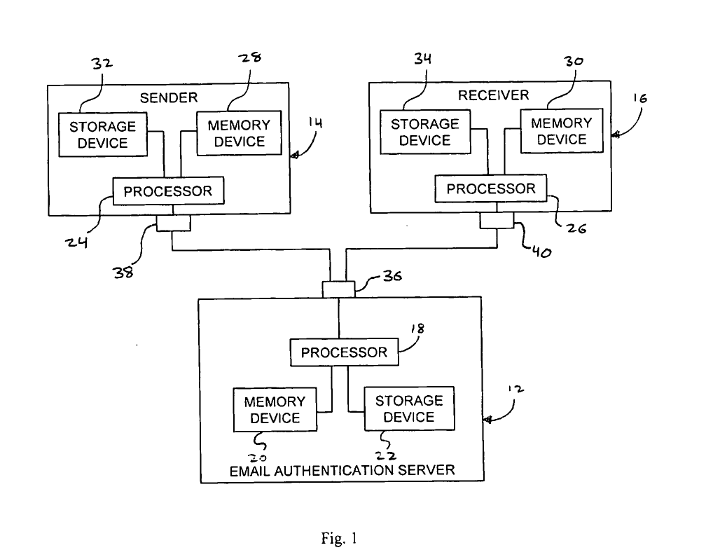

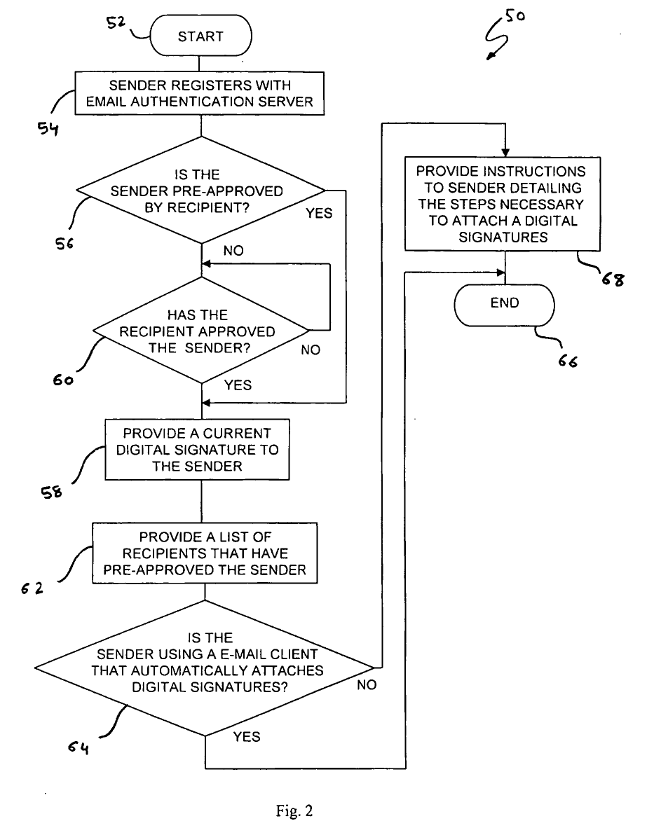

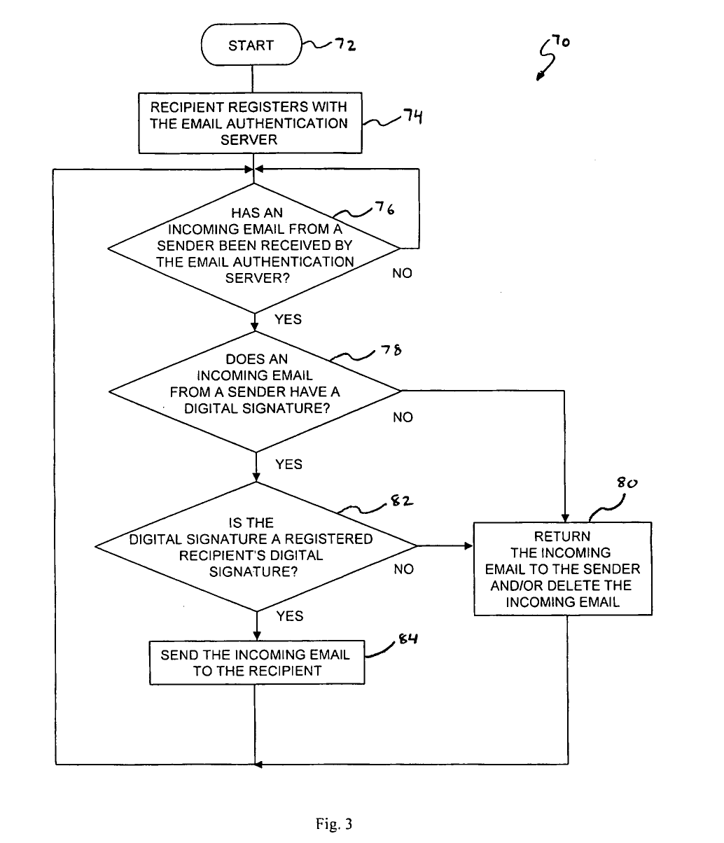

Referring to FIG. 1, a computer network 10 having an email authentication server 12, a sender 14 and a recipient 16 is shown. The email authentication server 12 includes a processor 18 in communication with a memory device 20 and a storage device 22. The email authentication server 12 may be a general purpose computer, such as a general purpose computer operating as an email server, or maybe a dedicated device, such as a router or a hand held device such as a personal digital assistant. The processor 18 is configured to receive instructions from the memory device 20. These instructions may include the methods that are described in FIGS. 2 and 3 that follow. The storage device 22 may be separate from the memory device 20 or may be incorporated into the memory device 20. The storage device 22 is used to store temporary data, similar to a hard disk for a general purpose computer.

The sender 14 and the recipient 16 may be general purpose computers capable of sending and receiving emails but may be a dedicated device capable of sending and receiving emails. Both the recipient 14 and the sender 16 each have processors 24, 26, respectively. Attached to the processors 24, 26 are storage devices 32, 34 and memory devices 28, 30, respectively. Similar to the email authentication server 12, the memory devices 28, 30 may contain instructions for executing the methods shown in FIGS. 2 and 3. Similarly, the storage devices 32, 34 may be temporary storage device, such as a hard disk. for storing data temporarily and potentially permanently.

The email authentication server 12, the recipient 14 and the sender 16 each further include network interface devices 36, 38, 40, respectively. These network interface devices 36, 38, 40 provide an interface for communication between the email authentication server 12, the sender 14 and the recipient 16. The network interface device of the email authentication server 12 may be connected to the network interface device 38 of the sender 14 via a wired or wireless communication. Similarly, the network interface device 36 of the email authentication server 12 may be connected to the network interface 40 of the recipient 16 via wired or wireless communication. The wired communication path may be a traditional copper twisted pair, cable, an optical communication path, or any other suitable land line communication path. The wireless communications path may be 802.11g or any suitable wireless networking communication path.

Referring to FIG. 2, a flow diagram of a method 50 for authenticating electronic communications is provided. These electronic communications may be emails exchanged between the sender 14 and the recipient 16, via the email authentication server 12. Generally, the method 50 is executed by the processor 18 of the email authentication server 12. The method 50 may be in the form of instructions contained within the memory device 20 of the email authentication server 12. As such, instructions having any of the methods described in the description may be embodied in a software upgrade for an email server.

The method 50 starts as denoted at step 52. In step 54, a sender registers with an email authentication server. In step 56, the email authentication server determines if the sender is preapproved by a recipient. If the sender is preapproved by the recipient, the email authentication server provides the recipient's current digital signature to the sender as shown in step 58.

As stated previously, the sender may be preapproved by the recipient. The send may provide the email authentication server a log containing a list of preapproved senders. If the sender is on this preapproved log listing, the email authentication server provides the recipient's current digital signature to the sender as shown in step 58. Additionally, so that the recipient can identify and make a determination if the sender should be approved, information may be communicated to the receiver containing sender information.

As shown in step 60, if the sender is not preapproved by the recipient, the sender will wait for the recipient's approval. The recipient may receive a communication from the email authentication server indicating that the sender is attempting to send an email to them. Additionally, if the sender indicates that the receiver is not to be approved, the email authentication server may notify the sender that the sender will not be allowed to communicate with the recipient.

Once the sender has been approved by the recipient, step 58 will execute and the recipient's current digital signature will be provided by the sender. Additionally, as shown in step 62, once the sender is either preapproved or approved by the recipient, the sender may be provided a list of other recipients that have preapproved the sender. By so doing, the sender knows which recipients have approved the sender.

The method 50 may also include step 64 which determines if the sender is using an email client that automatically attaches digital signatures. In order for the recipient to receive an email from the sender, the sender's email must contain the digital signature of the recipient. If the digital signature of the recipient is not attached to the email, the email authentication server 12 will not forward to the recipient. Therefore, the method 50 may determine if the sender is using an email client that automatically attaches digital signatures to emails. If the sender is using an email client that automatically attaches digital signatures, no action is taken and the method ends as denoted by step 66. However, if the sender is not using an email client that automatically attaches digital signatures, instructions will be provided to the sender detailing the steps necessary to attach digital signatures as shown in step 68. Thereafter, the method 50 ends as denoted by step 66.

Referring to FIG. 3, a method 70 for receiving an electronic communications between the sender 14 and the recipient 16 via the email authentication server 12 is shown. The method 70 begins at step 72. In step 74, the recipient registers with the email authentication server. Thereafter, step 76 determines if an incoming email from a sender has been received by the email authentication server. If no incoming email has been received, step 76 repeats. If an incoming email has been received, step 78 determines if the incoming email has a digital signature and step 82 determines if this digital signature is a registered recipient's digital signature. If either of these determinations is false, the incoming email may be returned from the sender and/or deleted from the email authentication server as shown in step 80. Otherwise, the incoming email is sent to the receiver as shown in step 84.

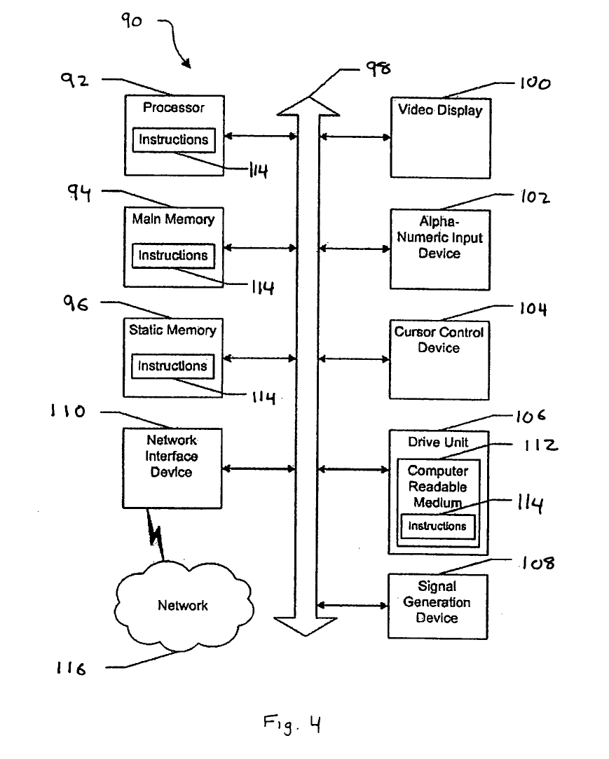

Referring to FIG. 4 an illustrative embodiment of a general computer system is shown and is designated 90. The computer system 90 may be the email authentication server 12 the sender 14 or receiver 16 of FIGS. 2 and 3. The computer system 90 can include a set of instructions that can be executed to cause the computer system 90 to perform any one or more of the methods or computer based functions disclosed herein. The computer system 90 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 90 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 90 can be implemented using electronic devices that provide voice, video or data communication. Further, while a single computer system 90 is illustrated, the term “system” shall also be taken to include any collection of systems or sub-systems that individually or jointly execute a set, or multiple sets, of instructions to perform one or more computer functions.

As illustrated in FIG. 4, the computer system 90 may include a processor 92, e.g., a central processing unit (CPU), a graphics processing unit (GPU), or both. Moreover, the computer system 90 can include a main memory 94 and a static memory 96 that can communicate with each other via a bus 98. As shown, the computer system 90 may further include a video display unit 100, such as a liquid crystal display (LCD), an organic light emitting diode (OLED), a flat panel display, a solid state display, or a cathode ray tube (CRT). Additionally, the computer system 90 may include an input device 102, such as a keyboard, and a cursor control device 104, such as a mouse. The computer system 90 can also include a disk drive unit 106, a signal generation device 108, such as a speaker or remote control, and a network interface device 110.

In a particular embodiment, as depicted in FIG. 4, the disk drive unit 106 may include a computer-readable medium 112 in which one or more sets of instructions 114, e.g. software, can be embedded. Further, the instructions 114 may embody one or more of the methods or logic as described herein. In a particular embodiment, the instructions 114 may reside completely, or at least partially, within the main memory 94, the static memory 96, and/or within the processor 92 during execution by the computer system 90. The main memory 94 and the processor 92 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 114 or receives and executes instructions 114 responsive to a propagated signal, so that a device connected to a network 116 can communicate voice, video or data over the network 116. Further, the instructions 114 may be transmitted or received over the network 116 via the network interface device 110.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for authenticating a sender with an authentication server, the sender when authenticated being capable of sending a communication to a recipient, the method comprising:
receiving instructions to register a sender upon request from an unregistered sender;
determining if the sender is approved by a recipient;
transmitting a current digital signature of the recipient to the sender if the sender is approved by the recipient.

2. The method of claim 1, further comprising transmitting a communication to the sender when the sender is not approved by the recipient.

3. The method of claim 2, wherein the communication comprises instructions for obtaining approval by the recipient.

4. The method of claim 1, wherein registering the sender with the email authentication server further comprises receiving contact information for the sender.

5. The method of claim 4, wherein the contact information comprises a name and an email of the sender.

6. The method of claim 5, wherein the contact information further comprises at least one of an address of the sender and a telephone number of the sender.

7. The method of claim 1, further comprising transmitting a list, the list comprising recipients that have approved the sender.

8. The method of claim 1, further comprising transmitting an updated digital signature when the current digital signature expires to the sender.

9. The method of claim 1, further comprising transmitting an updated digital signature when the current digital signature becomes compromised to the sender.

10. The method of claim 1, further comprising:
transmitting a communication to the receiver, the communication comprising information describing the sender, whereby the information describing the sender aids in identifying the sender.

11. The method of claim 1, further comprising transmitting the current digital signature of the recipient to the sender if the sender is on a preapproved list.

12. The method of claim 1, further comprising upgrading the authentication server with software, wherein the software contains processor executable instructions for authenticating the sender with the authentication server.

13. The method of claim 1, further comprising:
determining if the sender is using an email client capable of automatically attaching digital signatures;
transmitting instructions to the sender, the instructions containing information regarding manually attaching digital signatures.

14. An email authentication system, the system comprising:
a processor;
a network interface in communication with the processor, the network interface capable of receiving an email from a sender and forwarding the email to a recipient;
a memory unit in communication with the processor and having processor executable instructions for configuring the processor to receive instructions to register a sender upon request from an unregistered sender, determine if the sender is approved by the recipient, and provide a current digital signature of the recipient to the sender if the sender is approved by the recipient.

15. The system of claim 14, further comprising processor executable instructions to configure the processor to provide a communication to the sender when the sender is not approved by the recipient.

16. The system of claim 15, wherein the communication comprises instructions for obtaining approval by the recipient.

17. The system of claim 14, further comprising processor executable instructions to configure the processor to provide a list, the list comprising recipients that have approved the sender.

18. The system of claim 14, further comprising processor executable instructions to configure the processor to provide the sender with an updated digital signature when the current digital signature expires.

19. The system of claim 14, further comprising processor executable instructions to configure the processor to provide the sender with an updated digital signature when the current digital signature becomes compromised.

20. The system of claim 15, further comprising processor executable instructions to configure the processor to determine if the sender is using an email client capable of automatically attaching digital signatures, and provide instructions to the sender, the instructions containing information regarding manually attaching digital signatures.

21. The system of claim 14, further comprising processor executable instructions to transmit a communication to the receiver, the communication comprising information describing the sender, whereby the information describing the sender aids in identifying the sender.

22. A computer readable medium for authenticating a sender with an email authentication server, the computer readable medium comprising processor executable code for:
receiving instructions to register a sender upon request from an unregistered sender;
determining if the sender is approved by the recipient;
transmitting a current digital signature of the recipient to the sender if the sender is approved by the recipient.

23. The computer readable medium of claim 22, further comprising processor executable code for transmitting a communication to the sender when the sender is not approved by the recipient.

24. The computer readable medium of claim 23, wherein the communication comprises instructions for obtaining approval by the recipient.

25. The computer readable medium of claim 24, wherein registering the sender with the email authentication server further comprises processor executable code for transmitting contact information for the sender to the email authentication server.

26. The computer readable medium of claim 25, wherein the contact information comprises a name and an email of the sender.

27. The computer readable medium of claim 26, wherein the contact information further comprises at least one of an address of the sender and a telephone number of the sender.

28. The computer readable medium of claim 22, further comprising processor executable code for transmitting a list, the list comprising recipients that have approved the sender.

29. The computer readable medium of claim 22, further comprising processor executable code for transmitting an updated digital signature when the current digital signature expires to the sender.

30. The computer readable medium of claim 22, further comprising processor executable code for transmitting an updated digital signature when the current digital signature becomes compromised to the sender.

31. The computer readable medium of claim 22, further comprising processor executable code for transmitting the current digital signature of the recipient to the sender if the sender is on a preapproved list.

32. The computer readable medium of claim 22, further comprising processor executable code for:
determining if the sender is using an email client capable of automatically attaching digital signatures;
transmitting instructions to the sender, the instructions containing information regarding manually attaching digital signatures.

30. The computer readable medium of claim 22, further comprising processor executable code for:
transmitting a communication to the receiver, the communication comprising information describing the sender, whereby the information describing the sender aids in identifying the sender.
